(19) United States
(12) Patent Application Publication
(10) Pub. No.: US 2023/0372170 A1
(43) Pub. Date: Nov. 23, 2023

(54) DEVICE, SYSTEM, AND METHOD FOR TURNING, TRANSFERRING, AND CLEANING BED-RIDDEN PATIENTS

(71) Applicant: Gilbert De Alba, Fullerton, CA (US)

(72) Inventor: Gilbert De Alba, Fullerton, CA (US)

(21) Appl. No.: 18/321,381

(22) Filed: May 22, 2023

Related U.S. Application Data
(60) Provisional application No. 63/365,088, filed on May 20, 2022.

(51) Int. Cl. A61G 7/057; A61G 7/053; A61G 7/05

(52) U.S. Cl. CPC A61G 7/05723; A61G 7/05769; A61G 7/0536; A61G 7/0518

(57) ABSTRACT

A mattress for a bedridden patient, wherein the mattress provides one or more cutouts for access through an underside of the mattress. A removable insert may be associated with each cutout. The mattress provides a plurality of separate air columns selectively inflatable so to facilitate moving and turning the bedridden patient. The mattress is reinforced with an embedded strapping framework. Further, partially embedded arm straps extend from both longitudinal edges of the mattress for enabling a caregiver to fold over the mattress and secure the patient in a suspended position, whereby a caregiver can access a backside of the patient by way of the one or more cutouts.

### CROSS-REFERENCE TO RELATED APPLICATION

This application claims the benefit of priority of U.S. provisional application No. 63/365,088, filed May 20, 2022, the contents of which are herein incorporated by reference.

### BACKGROUND OF THE INVENTION

The present invention relates to hospital beds and, more particularly, a device, system, and method for turning, transferring, and cleaning bed-ridden patients.

Turning and cleaning bedridden patients is usually a two-person job, and caregivers typically find themselves spending more time looking for help, or risking hurting themselves performing the task alone. This problematic situation arises frequently because if caretakers do not turn a bedridden patient every two hours, there is a risk of the patient acquiring pressure ulcers.

Current hospital-bed transfer devices are usually bad for people's skin, leading to skin breakdown; as such, they are typically only used with transfers and turns. Specifically, the prior art is not configured to suspend patients, clean them, and wedge them to a side. Current devices either must be covered with a sheet to protect the skin or must be removed after being used, which requires more labor and/or demands that the patient undergoes more turns. These additional turns can prove to be more taxing on the caregiver and painful on the patient.

As can be seen, there is a need for a device, system, and method for turning, transferring, and cleaning bedridden patients that remedies the deficiencies of the prior art.

### SUMMARY OF THE INVENTION

The present invention is dimensioned and adapted to turn and clean patients, as well as transferring them from bed. The device embodied in the present invention helps turn patients and keep them safely suspended for patient care. It can also be used to transfer patients and has other features which are described below and in the Figures.

The present invention utilizes air pressure to help avoid pressure ulcers; using a computing device, the present invention is specifically configured to be safe for the skin of patients.

The present invention organizes the incontinence lines.

Furthermore, the present invention requires less manpower than the prior art as the device disclosed is adapted for one individual to operate successfully for most patients, as compared to the prior art which is a two-person proposition.

In one aspect of the present invention, a mattress for bedridden patients, the mattress including the following: a plurality of air columns, wherein each air column is independently inflatable; a first cutout adapted to be adjacent to a coccyx region of a patient, wherein the first cutout interrupts at least two of the plurality air columns into two segments; and for each interrupted air column, an air tunnel fluidly connects the two segments; a first insert dimensioned and shaped to be coextensive with and removably attached with the first cutout; and an air inlet fluidly provided along the first insert to mate with an air outlet along an adjacent air tunnel for inflating the first insert; a second cutout adapted to be adjacent to an upper back regions of the patient; and; a second insert dimensioned and shaped to be coextensive with and removably attached within the second cutout; and a urinal insert disposed in a urinal cutout of the mattress, wherein the urinal insert is fluidly coupled to the plurality of air columns by way of the first insert; and further including a plurality of tube inserts within the mattress for embedding tubing that extends from the urinal cutout; an air pump fluidly coupled to the plurality of air columns so as to selectively inflate each air column, wherein an airflow from the air pump inflates individual air columns so that the plurality cascade from one longitudinal edge to opposing longitudinal edge; and a linen having a surface coextensive with the mattress, wherein said surface has a first linen cutout and a second linen cutout coextensive with the first and second cutouts, respectively.

In another aspect of the present invention, a mattress for bedridden patients, the mattress includes: a plurality of longitudinal straps and a plurality of latitudinal straps disposed between an upper surface, a lower surface, and two opposing longitudinal edges of the mattress, wherein each longitudinal strap overlaps at least one of the plurality of latitudinal straps, wherein each strap is housed in an enclosure; and a plurality of arm straps extending beyond both two opposing longitudinal edges so that urging one or more of the arm straps along one of the two opposing longitudinal edges cause the mattress to fold lengthwise due to the plurality of the longitudinal and latitudinal straps, wherein the plurality of arm straps emerge from a middle third of a thickness of the mattress defined by the upper and lower surfaces; a bedrail adjacent to one or both two opposing longitudinal edges, wherein each distal end of the urged arm straps have a clamp removably attachable to the bedrail, thereby securing the folded mattress in a suspended condition; a first cutout adapted to be adjacent to a coccyx region of a patient, wherein the first cutout interrupts at least two of the plurality air columns into two segments; and for each interrupted air column, an air tunnel fluidly connects the two segments.

These and other features, aspects and advantages of the present invention will become better understood with reference to the following drawings, description, and claims.

### BRIEF DESCRIPTION OF THE DRAWINGS

FIG. 1: is a top perspective view of an exemplary embodiment of the present invention, shown in use.

FIG. 2: is a top perspective view of an exemplary embodiment of the present invention, without linen.

FIG. 3: is a bottom exploded perspective exploded view of an exemplary embodiment of the present invention, including linen.

FIG. 4: is a top view of an exemplary embodiment of the present invention, with exterior elements shown in hidden lines to shown interior components.

FIG. 5: is a detailed section view of an exemplary embodiment of the present invention, taken along line 5-5 in FIG. 4.

FIG. 6: is a detailed section view of an exemplary embodiment of the present invention, taken along line 6-6 in FIG. 4.

FIG. 7: is a detailed perspective view illustrating the controller hookup to the air system.

FIG. 8: is a top schematic view of the airflow system, with elements exaggerated or removed for clarity.

FIG. 9A: is a schematic section view, taken along line 9-9 in FIG. 8, showing all air columns inflated.

FIG. 9B: is a schematic section view, showing the variable partial deflation of columns: the first air column, from the left margin, has the least amount of the air pressure, and the remaining air columns has sequentially greater air pressure, whereby the differential air pressure results in an overall sloped configuration, wherein the border walls 93 always have a constant elevation, which facilitates the turning of a bedridden patient.

FIG. 9C: is a schematic section view, showing another instance of the variable partial deflation of columns, selectively inflating separate columns, wherein the first and third columns are inflated to the maximum and thus are rectangular in cross-section as comparted to FIG. 9B.

FIG. 10: is a detail exploded perspective view of the inserts, with the belts 65 not shown to clarify interior elements.

FIG. 11: is a detailed perspective view with a tube in holders 46.

FIG. 12: is a rear perspective view of the controller, illustrating its connection to sequential compression devices, which can provide external pressure to portions of the bedridden patient; for instance, their calf.

FIG. 13: is a bottom perspective exploded view of an exemplary embodiment of the present invention, illustrating an alternate securement method for the inserts.

FIG. 14A: is a top perspective view of an exemplary embodiment of the present invention, illustrating the lifting of the straps to turn the patient.

FIG. 14B: is a top perspective view of an exemplary embodiment of the present invention, illustrating the securing of the pad and patient in the turned position.

FIG. 14C: is a top perspective view of an exemplary embodiment of the present invention, illustrating the release of the coccyx insert to care for the patient secured in the lifted condition.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

An itemized part list may include the following:
10: is the mattress
12: are the top grips
14: are the lower grips
16: are the corner straps
18: is the back insert slot
20: is the coccyx insert slot
22: is the urinal insert slot
24: are the foley tunnels
26: is the air hose port
27: is the female hose coupler
28: are the linen attachment buttons
30: are the buckle slots
32: are the tube slots
34: are the foley tunnel top slits
36: are the hooks
38: are the adjustable straps
40: are the hooks
42: are the adjustment buckles
44: are the strap bumpers
46: are the tube holders
48: is the back insert
50: is the coccyx insert
52: is the urinal insert
54: are the back insert tube slots
56: are the coccyx insert tube slots
58: are the back insert tubes
60: are the coccyx insert tubes
62: is the coccyx insert tube slot
64: are the insert buckles
65: are the insert belts
66: is the controller
67: are the insert belt tongues
68: are the hangers
70: is the display screen
72: is the air tube connector
74: are the rubber stoppers
76: is the power connection
78: are the air vents
80: is the power button
82: is the menu button
84: is the selection button
86: are the rear ports
88: is the air hose
89: is the male hose coupler
90: is the air splitter
91: is the air
92: are the partitions
93: is the outer border
94: are the coccyx insert air tunnels
96: are the back insert air tunnels
98: are the vertical strap enclosures
100: are the horizontal strap enclosures
102: are the horizontal straps
104: are the support strap enclosures
106: are the support straps
108: is the emergency release
110: are the sequential compression device (SCD) hoses with plugs
112: are the spring clips
114: are the SCDs
116: are the tube storage straps
118: are the tube holders
120: are the SCD tubes
122: is the alternate back insert retainer
124: is the alternate coccyx insert retainer
126: are the hooked fastener strips
128: are the looped fastener strips
130: is the sheet with customer cutouts
132: is the bed
134: is the patient
136: is the tube
138: are the bed rails
140: is the caregiver

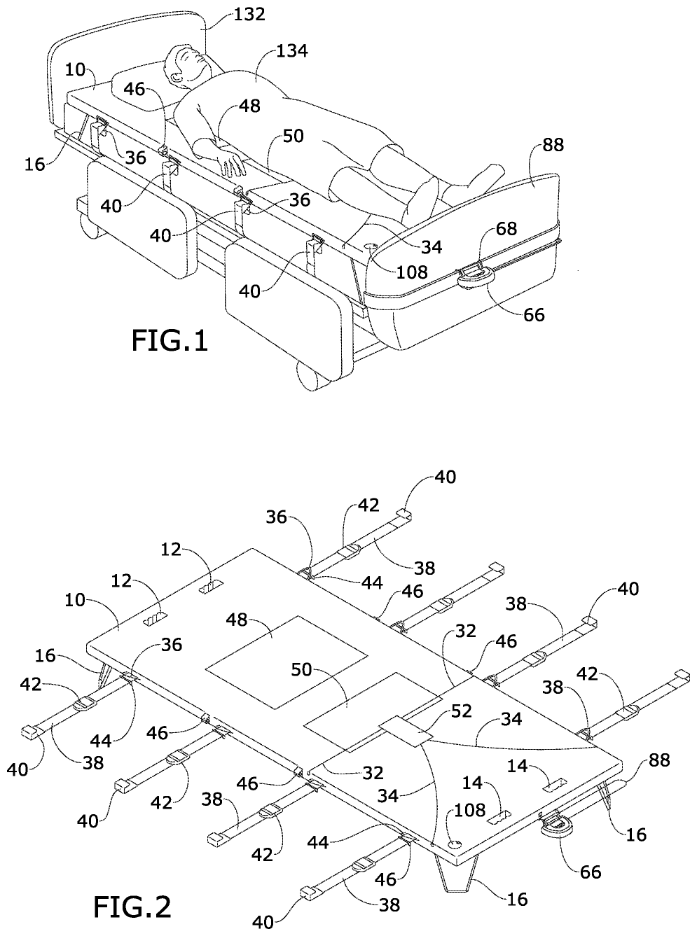

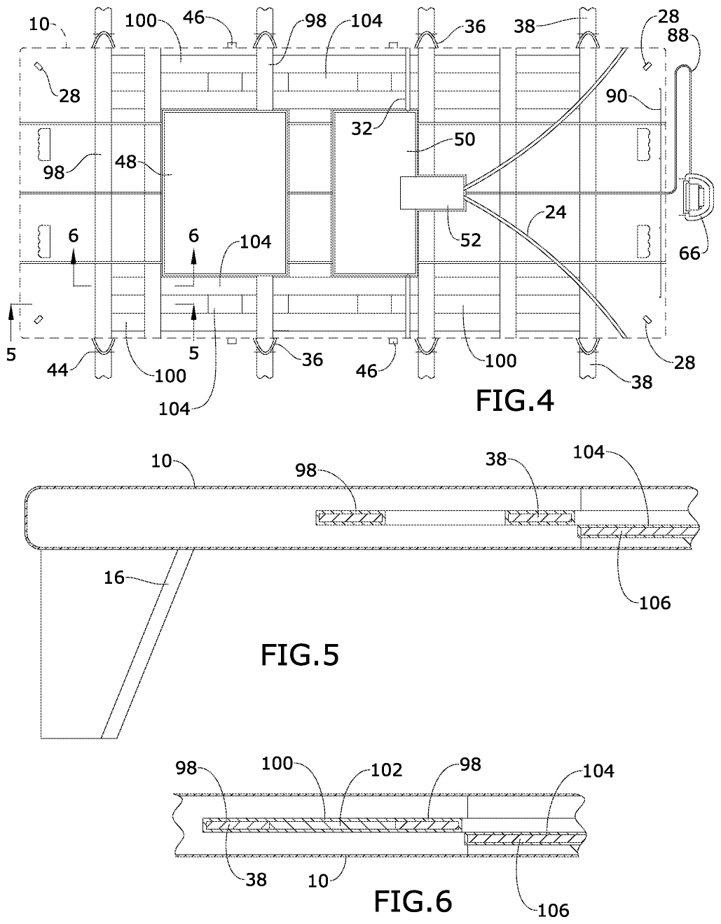

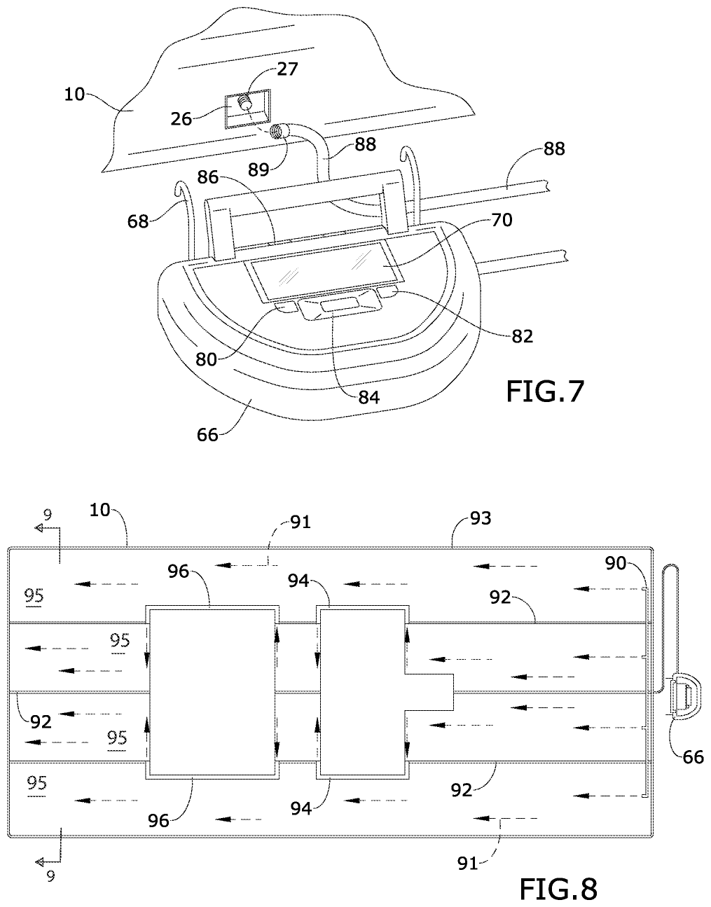

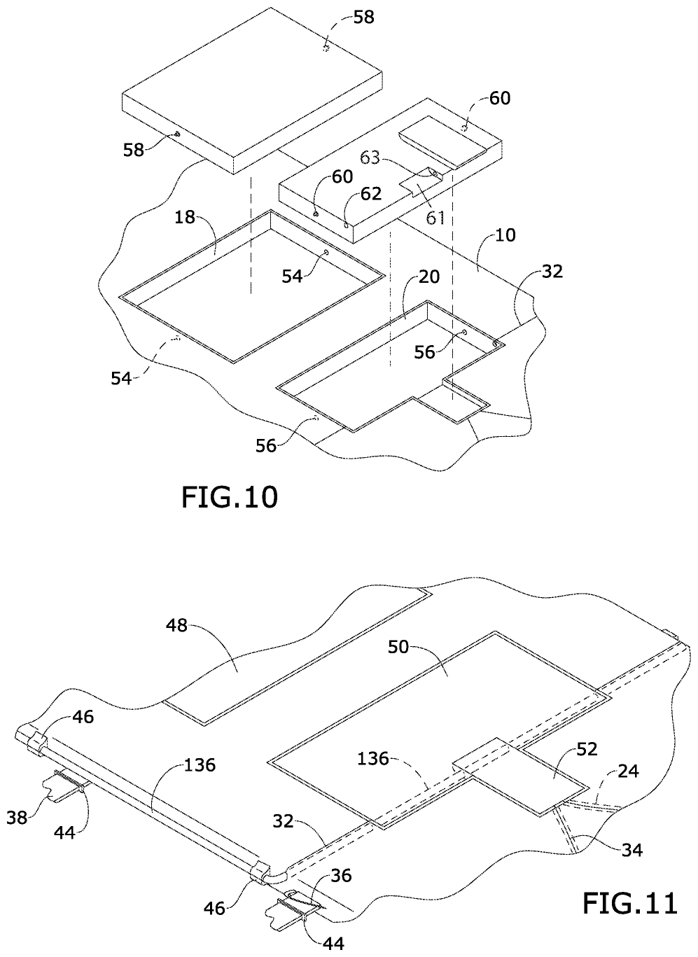

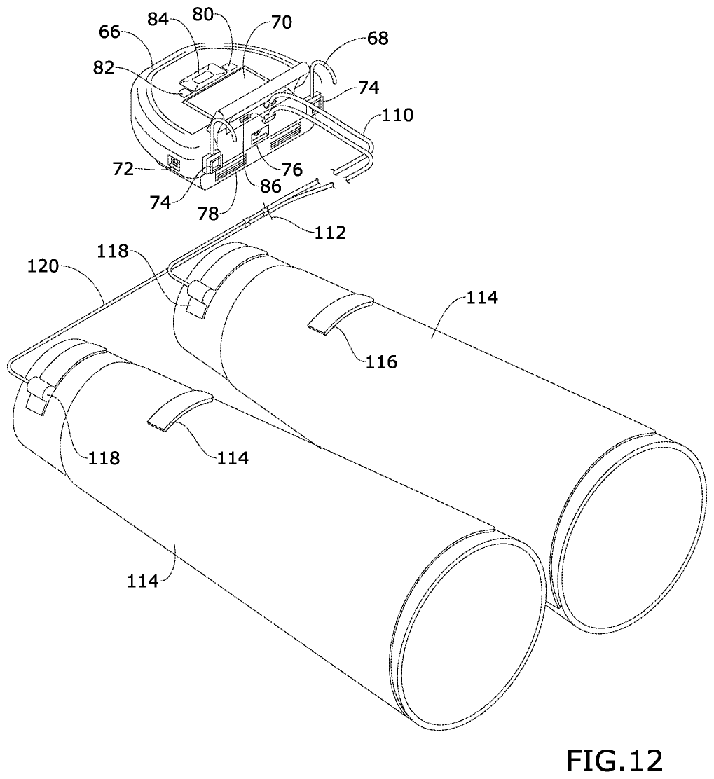

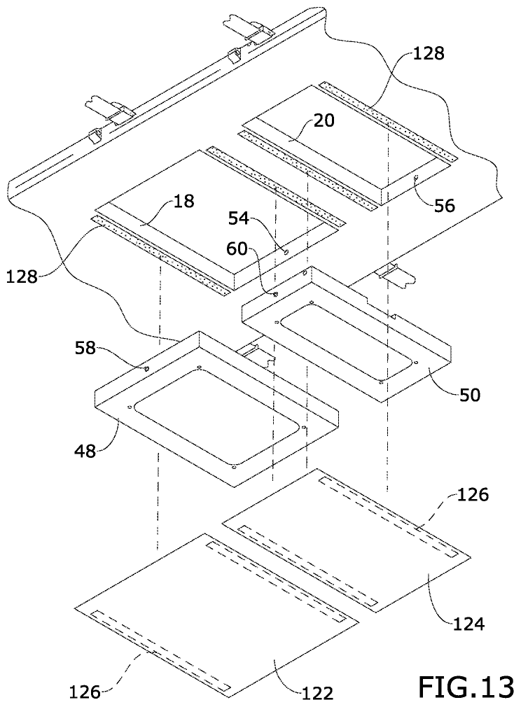

Referring now to FIGS. 1 through 14C, the present invention may include a mattress 10 defining a plurality of air columns, wherein each air column is separately and selectively inflatable by way of an airflow system to facilitate moving and turning bedridden patients 134 using air pressure.

The mattress 10 may provide an internal reinforcing system providing a web of strapping. The web of strapping includes a plurality of adjustable straps 38 that protrude from opposing longitudinal edges of the mattress 10 in a spaced apart relationship to facilitate a caregiver 140 turning the bedridden patient 134 while supine along the mattress 10, whereby the mattress 10 moves to a folded position, like a sandwich wrap, as one longitudinal edge is moved closer to its opposing longitudinal edge. The adjustable straps 38 can also be secured, by way of the hooks/clamp 40 along the distal end of each strap 38, to a bedrail 138 associated with that opposing longitudinal edge so that the bedridden patient 134 is secured in a suspended condition.

The mattress 10 may provide cutouts 18, 20; one upper back cutout 18 and another, spaced apart, coccyx cutout 20. The upper back cutout 18 is dimensioned and shaped to align with an upper back region of the bedridden patient 134 laying on the mattress 10 in the supine position. The coccyx cutout 20 is dimensioned and shaped to align with a coccyx region of the bedridden patient 134 laying on the mattress 10 in the supine position. The coccyx region is an area including and circumscribing the coccyx of the user 134 (the coccyx is commonly referred to as the “tailbone” and is the final segment of the vertebral column). Accordingly, when the bedridden patient 134 is secured in the suspended condition, the caregiver 140 can directly access their upper back and coccyx regions through the cutouts 18 and 20.

A back insert 48 and coccyx insert 50 are dimensioned and shaped to be received in the respective back cutout 18 and coccyx cutout 20. The back insert 48 and coccyx insert 50 may be fluidly coupled to the airflow system to be selectively inflatable when fitted in their respective cutout, thereby facilitating a snug engagement between the insert and cutout that makes the mattress whole. The inserts 48, 50 may be fastened into their respective cutouts by way of hook and loop fasteners, a belt system, or any other detachable fasteners. The belt system may include belts 65 ending in insert tongues 67, wherein the insert tongues are adapted to removably engage buckle slots 30 and/or insert buckles 46 disposed along an underside of the mattress 10.

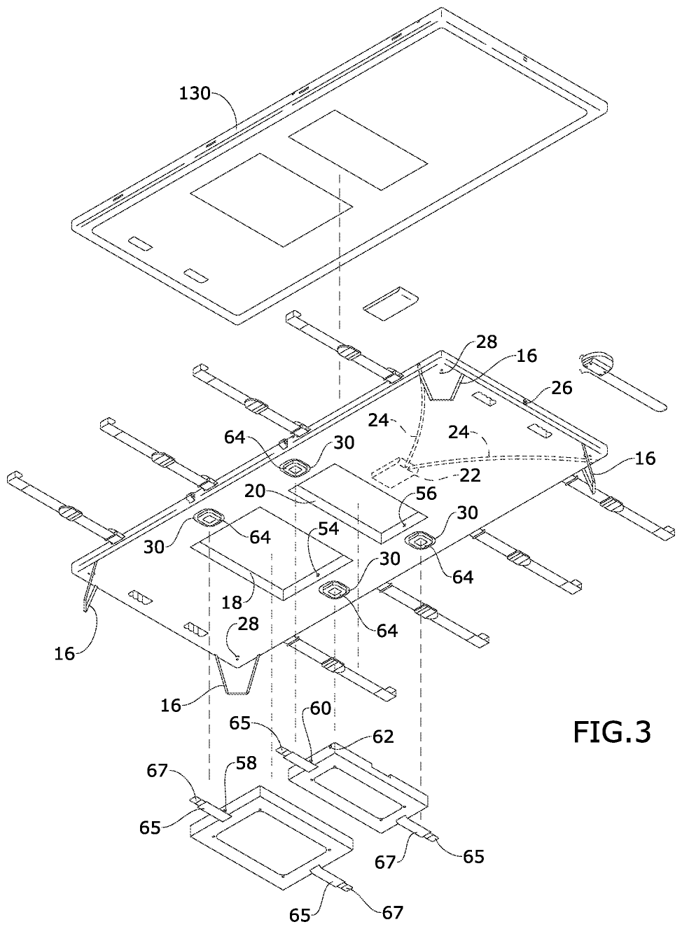

Each insert 48, 50 may provide air inlets 58, 60 for fluidly coupling to air outlets along a periphery of the inserts cutout, as shown in FIG. 3, thereby the air system, by way of an air pump, that selectively pressurizes the air columns from an external air pressure source can selectively inflate the respective inserts 48, 50.

Inferiorly depending from a distal edge of the coccyx cutout 20, in some embodiments, may be a cutout for an urinal insert 52. The coccyx cutout 20 may communicate with the urinal cutout. In some embodiments, the coccyx insert 50 may provide a urinal recess 61 a portion of the urinal insert 52 is seated in. Along a sidewall of the urinal recess may be an air outlet 63 fluidly coupled to the urinal insert 52 for selectively inflating it.

Inferiorly depending from a distal edge of the urinal insert 52 may be one or more foley tunnel slits 34 that distally extend to a (left and/or right) longitudinal edge of the mattress 10 (or possibly an inferior edge thereof). The foley tunnel slits 34 may be used to embed conduits, such as incontinence or chest tubes, in an organized, stable manner. At both exits of the foley tunnel slits 34 may be a soft clamp 46 that holds incontinence lines 136 and leads them up against the mattress 10 to another set of soft clamps 46, further up, adjacent to a superior portion of the mattress 10, as illustrated in FIG. 11. In some embodiments, two foley tunnel slits 34 meet at the urinal insert 52 and curve out in the shape of a half parabolas, left and right. Likewise, tube slots 32 may extend laterally from both sides of the urinal insert 52 (along or adjacent a distal edge of the coccyx cutout 50). The tube slots 32 may also engage/embed incontinence lines, chest tubes or other conduits to guide them to the left and right longitudinal edges.

Along or just inward of a superior and inferior edges of the mattress 10 may be one or more grip-shaped cutouts 12, 14 usable to pull the mattress up and down. There may be another removable cutout that transverses between the mattress and below the lower cutout that when is removed from the mattress gives a leveled space for the usage of a urinal without risking the bottle tipping over causing spillage.

Inside the mattress 10 may be a reinforcing system including a web of longitudinal straps 102 and lateral straps 106 that may be interwoven or overlapped with each other to strengthen the integrity of the mattress 10 when its lifted or suspended. Running laterally 10 there may be two lateral straps 106 next to each other coming from the left of the mattress 10. There may be two other lateral straps 106 coming from the right of the mattress 10. There may be a plurality of longitudinal straps 100 running longitudinally, some longitudinal straps 100 may be at the superior and inferior end. They may meet with the lateral straps 106 and form a rectangle. A longitudinal strap 102 may extend inferiorly from a superior lateral strap 106, and below that one is the next lateral strap 106. Then, there may be another lateral strap 106 that is below that one, etc., so that the longitudinal and lateral straps 102 and 106 form a support mesh or strapping framework that supports the integrity of the mattress. The longitudinal straps 102 and the lateral straps 106 may reside and be housed in respective strap enclosures 98 and 104.

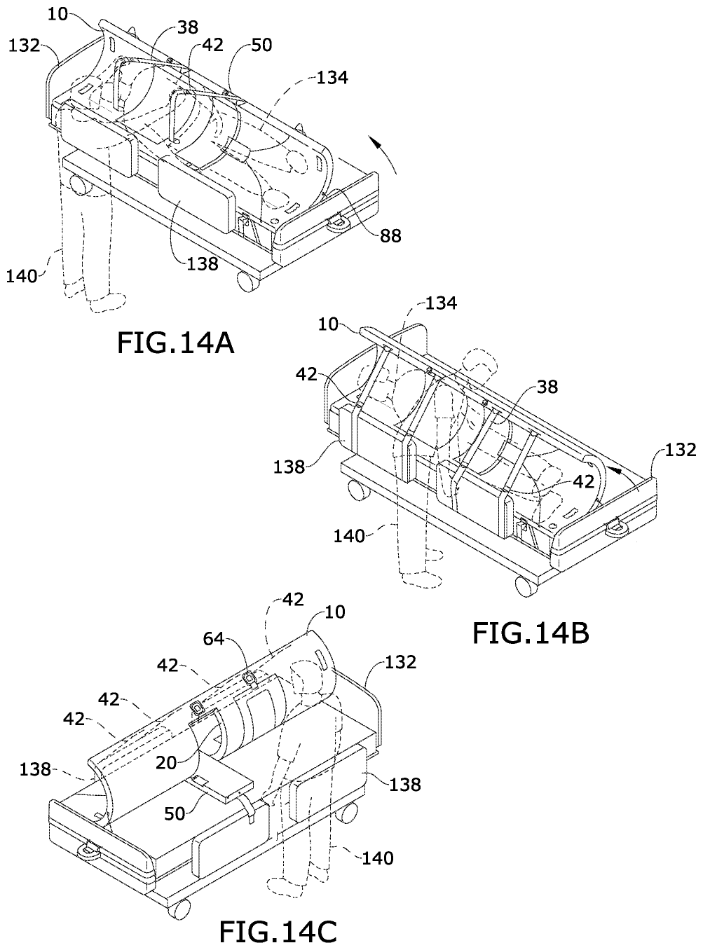

In some embodiments, to the left and right of some of the lateral straps 106 (or extensions thereof) may be adjustable straps 38 that protrude from both opposing longitudinal edges of the mattress 10. The adjustability may be performed by way of adjustors 42, including but not limited to buckles. At the end of the adjustable straps 38, there may be spring-biased spring claw grips 40, made from hard plastic or the like, that open wider when stretched open. These open wide to fit different side rails and may be used when the bedridden patient 134 is in bed and the mattress 10 is being used to turn the bedridden patient 134. These “arms”/adjustable straps 38 may be used to pull the patient to the side by folding over the mattress 10, as illustrated in FIG. 14A, and then the pulled-over arm straps 38 may be anchored, by way of the claw grips 40, to the side pads/rails 138, as illustrated in FIG. 14B. The arm straps 38 may be stitched through the rest of the inside of the mattress 10. arm straps 38. The same goes for the right side as there may be a plurality of straps.

Resting above where the adjustable straps 38 meet the inside of the mattress may be strap bumpers 44 and lift handles 36 that are used to pick up the mattress using a lifting device. There may be a plurality of lift handles in total.

As mentioned above, and referring to FIGS. 14A through 14C, the adjustable straps 38 may be used when turning the patient 134 on the mattress 10. Caregiver 140 may reach over the bedridden patient 134 and begins by grabbing the two middle straps 38 from across the bedridden patient 134. The caregiver 140 may then pull the straps 38 towards themselves and secures the straps under the rail closest to them using the claw grips 40. The caregiver 140 can then take the top and bottom straps 138 and then do the same. The patient 134 should now be secured in a suspended position, whereby the caregiver 140 can now either “open the door”—i.e., remove the coccyx insert 50—located in the coccyx region to commence perineal care or put wedges to keep the bedridden patient turned. The lifting handles may be used when the mattress is being lifted by a lift such as a ceiling lift or Hoyer lift. The airway is where air passes through into the mattress from the computer air system.

The outside layer of the mattress 10 may be a soft material that is safe for the patient 134 and is also sweat and stain proof. The outside layer of the mattress 10 may be supported by the inside of the mattress 10 when used to move the patient 134. The urinal insert 52 is removable from a urinal insert slot 22 spaced apart from the coccyx insert slot 50. The urinal insert 52 is used for when a male patient wants to use a urinal in bed 132. When removed, it provides space for the urinal.

Along an edge of the mattress 10, may be an air hose port 26 adapted to receive an air hose 88 for selectively inflating the mattress 10 by way of an air/fluid system. The hose 88 may be fluidly coupled to the air hose port 26 by way of a first hose coupler 27 and a complementary second hose coupler 89. Such a device may also be fluidly coupled to the inlets 58, 60, 62 of the inserts 48. 50.

Referring to FIG. 8, the interior of the mattress 10 may be divided into a plurality of air columns 95 by way of partitions 92 and outer borders 93 that are evenly spaced apart in parallel. The straps 102, 106 located inside the mattress may be housed (in the respective enclosures 98, 104) away from the air columns 95 to prevent air leakage. Each air column 95 receives airflow/pressure 91 independently, by way of a manifold 90, from each other to achieve different tasks. Both upper back and coccyx inserts 48, 50 also receive air to inflate via the first through n^{th} column, by way of air tunnels 96 and 94, respectively. The region in-between these inserts are inflated via air tunnels 96 that are fed from the intermediate columns that are housed around the coccyx insert 50, as illustrated in FIG. 8. The region above the upper back insert 48 may be provided airflow 91 through an additional set of air tunnels 96 that receive air from the in-between region previously mentioned. These air tunnels 96 may be housed around the upper back insert 48.

At the bottom corners of the mattress 10 are stretchable harnesses 16 that secure the mattress on top of the other mattress that is below it.

Controlling the air pressure of the mattress may be a computer air system having a computer 66 with button controls that inflate and deflate the mattress a significant number of ways. This computer 66 may be fluidly connected to the air mattress via the hose 88. The computer 66 may provide a display screen 70 along with a power button 80, a menu button 82, a selection button 84. The computer 66 may be removable attached to the bed 132 or mattress 10 by way of hangers 68 or the like.

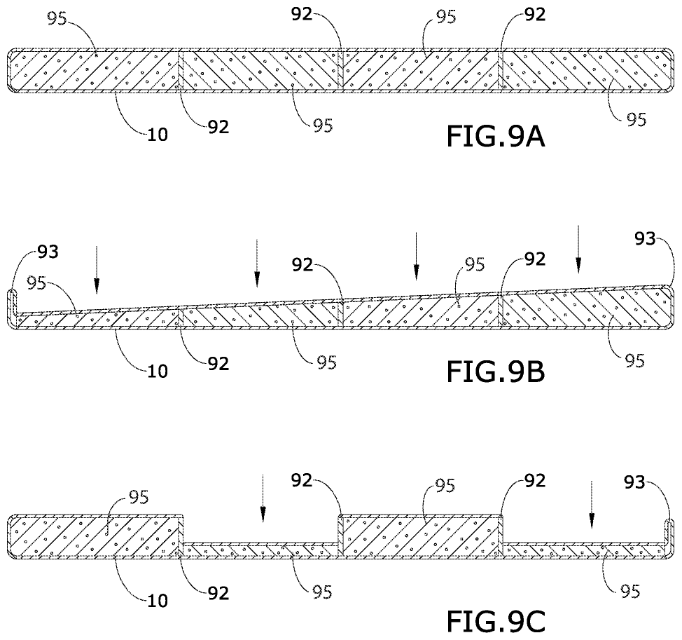

There may be a plurality of settings/mode that change the pressure in the mattress to achieve different tasks. The first setting may be called Ideal mode. In this mode, the computer calculates and inflates the mattress to achieve a pressure that faintly raises the patient off the bottom of the mattress to combat the odds of receiving a pressure ulcer caused by the bed. The second setting may be called max inflate mode. In this mode, the mattress is filled to a maximum capacity, and with the harnesses removed from the bottom of the mattress, the mattress can then slide more easily for transfers. The third setting may be the max deflate mode. In this setting, the mattress is completely deflated and is ready to use for either turning the patient 134 or lifting the patient 134 via lift. The fourth setting may be the turn assist mode. In this mode, the air pressure in the individual columns of the mattress vary so that they cascade from left to right or the opposite, thus achieving an automatic turn, as illustrated in FIG. 9B. This setting can be customized so that turns can alternate between left turn, right turn, or evenly for the back side every two hours. The fifth setting may be the linen change mode. In this mode, the odd and even numbered air columns, see FIG. 9C, may alternate in max inflation and sub inflation to create spaces underneath the patient. The mattress automatically alternates for a few seconds, giving the caregiver enough time to feed the customized linen underneath the patient 134 without requiring the patient to turn. The computer may also power and program a set of sequential compression devices.

The present invention may include a customized linen 130 for the mattress 130. The main linen piece 130 may be cut to fit the top of the mattress and may be secured underneath the corner of the mattress via connectors 28, such as buttons. Because the mattress is inflated when the linen 130 is changed, there may be a space provided by where the button is met so there is no air in the way that would then cause difficulty when securing the linen. This main linen piece 130 does not cover any of the sides of the mattress also has cut outs for the upper back and coccyx inserts 48, 50. These inserts 48, 50 have their own individual linen pieces that also button at the bottom and have cutouts for their air systems.

The point of the mattress 10 is to make patient care easier and quicker so patient needs are met. The air mattress 10 is powered by a computer 66. The computer 66 keeps the mattress 10 inflated enough so the patient does not develop pressure ulcers. It measures and maintains pressure in the bed, so the patient's body does not touch the bottom of the mattress 10. The arms/adjustable straps 38 are hidden on the side of the mattress 10 and can be pulled out and used to turn the patient 134 from side to side. The arms/adjustable straps 38 are adjustable to secure patients 134 of a size and weight to a particular side. The handles located above the arms are used for when the caregiver 140 wants to transfer the patient 134 from the bed 132 using a lift. The lifts arms are then strapped with the handles while the mattress 10 is deflated, and then the mattress 10 itself can be lifted using a variety of lifts. The inside of the mattress 10 is strengthened with inter-webbed straps 100 and 106 of suitable material. The slits 32, 34 in the lower region of the mattress 100 are used to organize incontinency lines to keep them away from the patient 134 and helps avoid bends and kinks to the lines.

A method of manufacturing the present invention may include the following. First the outer mattress may be cut in shape with opening of the top and bottom grips in mind, as well the incontinence lines, and then the inside of the mattress needs to be sewn together and fitted inside the outer mattress with the arms connected to inside side of the mattress. The arms may be fitted in adjustable straps and woven into the adjustable grip that is supported with springs to pull open to fit the bottom of any side rail. Then, the top layer of the mattress can be sewn shut. The airway for the mattress then may be cut out and then a connector needs to be glued in place to receive air for the hose. The handles can now also be applied above each arm strap and sewn together.

Something that could make the mattress 10 easier to work with a separate bottom sheets 122, 124 that hook and loop fasteners 126, 128 to air mattress and that harnesses to the lower mattress. This way, when turning the mattress from side to side, the mattress rips off the hook and loop fasteners instead of needing to unharness the corners of the bed.

A method of using the present invention may include the following. A caregiver would not seek out the help of another person to turn the patient and secure the patient in place while the first caregiver cleans the patient, like they would when operating the prior art. Rather, with the mattress, a caregiver just needs to deflate the mattress by pushing the deflate button and unstrapping the harnesses from each corner. Now, the caregiver takes the two middle straps from across the bed and pulls them towards themself, making the patient face them, and then securing the straps underneath the bed rails 138 in front of them. The caregiver can now go to the other side, open the hook and loop fasteners door to either check on the patient's back and bottom, or clean the patient. They can replace the incontinence pad and reseal the door when finished. They can then put a wedge or pillow down to keep the patient turned to that side in desired. Finally, the caregiver can go back, un-grip the arm strap and slowly allow the patient to turn back with their back on the bed. The arms can then be neatly tucked away.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A mattress for bedridden patients, the mattress comprising:
a plurality of air columns, wherein each air column is independently inflatable;
a first cutout adapted to be adjacent to a coccyx region of a patient, wherein the first cutout interrupts at least two of the plurality air columns into two segments; and
for each interrupted air column, an air tunnel fluidly connects the two segments.

2. The mattress of claim 1, further comprising:
a first insert dimensioned and shaped to be coextensive with and removably attached with the first cutout; and
an air inlet fluidly provided along the first insert to mate with an air outlet along an adjacent air tunnel for inflating the first insert.

3. The mattress of claim 2, further comprising:
a second cutout adapted to be adjacent to an upper back regions of the patient; and
a second insert dimensioned and shaped to be coextensive with and removably attached within the second cutout.

4. The mattress of claim 3, further comprising:
a urinal insert disposed in a urinal cutout of the mattress, wherein the urinal insert is fluidly coupled to the plurality of air columns by way of the first insert.

5. The mattress of claim 4, further comprising a plurality of tube inserts within the mattress for embedding tubing that extends from the urinal cutout.

6. The mattress of claim 5, further comprising an air pump fluidly coupled to the plurality of air columns so as to selectively inflate each air column, wherein an airflow from the air pump inflates individual air columns so that the plurality cascade from one longitudinal edge to opposing longitudinal edge.

7. The mattress of claim 6, further comprising a linen having a surface coextensive with the mattress, wherein said surface has a first linen cutout and a second linen cutout coextensive with the first and second cutouts, respectively.

8. A mattress for bedridden patients, the mattress comprising:
a plurality of longitudinal straps and a plurality of latitudinal straps disposed between an upper surface, a lower surface, and two opposing longitudinal edges of the mattress, wherein each longitudinal strap overlaps at least one of the plurality of latitudinal straps, wherein each strap is housed in an enclosure; and
a plurality of arm straps extending beyond both two opposing longitudinal edges so that urging one or more of the arm straps along one of the two opposing longitudinal edges cause the mattress to fold lengthwise due to the plurality of the longitudinal and latitudinal straps, wherein the plurality of arm straps emerge from a middle third of a thickness of the mattress defined by the upper and lower surfaces.

9. The mattress of claim 8, further comprising:
a bedrail adjacent to one or both two opposing longitudinal edges, wherein each distal end of the urged arm straps have a clamp removably attachable to the bedrail, thereby securing the folded mattress in a suspended condition.

10. The mattress of claim 9, further comprising:
a first cutout adapted to be adjacent to a coccyx region of a patient, wherein the first cutout interrupts at least two of the plurality air columns into two segments; and
for each interrupted air column, an air tunnel fluidly connects the two segments.
